(19) United States
(12) Patent Application Publication
(10) Pub. No.: US 2011/0093540 A1
(43) Pub. Date: Apr. 21, 2011

(54) Method and system for communications using cooperative helper nodes

(75) Inventors: Yiftach Eisenberg, Washington, DC (US); Rachel E. Learned, Waltham, MA (US); Karl D. Brommer, Exeter, NH (US)

(73) Assignee: BAE SYSTEMS INFORMATION AND ELECTRONIC SYSTEMS INTEGRATION INC., Nashua, NH (US)

(21) Appl. No.: 12/923,632

(22) Filed: Sep. 30, 2010

Related U.S. Application Data
(60) Provisional application No. 61/247,515, filed on Sep. 30, 2009.

(51) Int. Cl. G06F 15/16; H04W 4/00

(52) U.S. Cl. 709/205; 370/328

(57) ABSTRACT

A method and system for communicating a message are disclosed. An exemplary system includes plural nodes and an exemplary information transmitter that includes a processor. The processor can detect a number of the nodes within communication range of the information transmitter as helper nodes. The processor can process a message into a number of portions as a function of the number of helper nodes detected. The processor can transmit at least one of the portions of the message to at least one of the helper nodes for wireless communication of at least one portion by the at least one helper node.

### RELATED APPLICATION

This disclosure claims priority under 35 U.S.C. §119 to U.S. Provisional Application No. 61/247,515 filed Sep. 30, 2009, the content of which is incorporated herein by reference in its entirety.

### FIELD

The subject matter presented herein relates generally to communications, for example wireless communications.

### BACKGROUND

Point-to-point based communications (i.e. unicast) links, where a single source transmits radio frequency (RF) information directly to a single destination are known. Communication performance can be a function of resources at the source node, which can communicate at a fixed rate. Utilizing one or more relay nodes between the single source and single destination can increase SNR (signal-to-noise ration) but communication still occurs at a fixed rate.

Distributed beamforming can be used to sum weaker transmissions of multiple sources into a stronger transmission. Distributed beamforming involves space, time, frequency, and phase synchronization and coordination which can impact the complexity and cost of a communications link. For source nodes with relatively small power sources and/or antennas, the rate at which they can communicate with the destination can be very low, often too low for practical applications.

BitTorrent is a known protocol for distributing information to many peers over the Internet. Using the BitTorrent protocol, any given peer can attempt to maximize its own download rate. Since each peer can act for itself, there can be a lack of organization in the peers, which can contribute to transmission inefficiency.

### SUMMARY

An exemplary system is disclosed for communicating a message. The system includes plural nodes and an information transmitter that includes a processor. The processor can detect a number of the nodes within communication range of the information transmitter as helper nodes, and can process a message into a number of portions as a function of the number of helper nodes detected. The processor can transmit at least one of the portions of the message to at least one of the helper nodes for wireless communication of at the least one portion by the at least one helper node.

An exemplary method for wireless transmission includes detecting a number of the nodes within communication range of an information transmitter as helper nodes. The method includes processing a message into a number of portions as a function of the number of nodes detected, and transmitting at least one of the portions of the message to at least one of the helper nodes for wireless communication of the at least one portion by the at least one helper node.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 shows an exemplary embodiment of a system for communicating a message;

FIG. 2 shows another exemplary embodiment of a system for communicating a message; and

FIG. 3 shows an exemplary embodiment of an information transmitter.

### DETAILED DESCRIPTION OF EXEMPLARY EMBODIMENTS

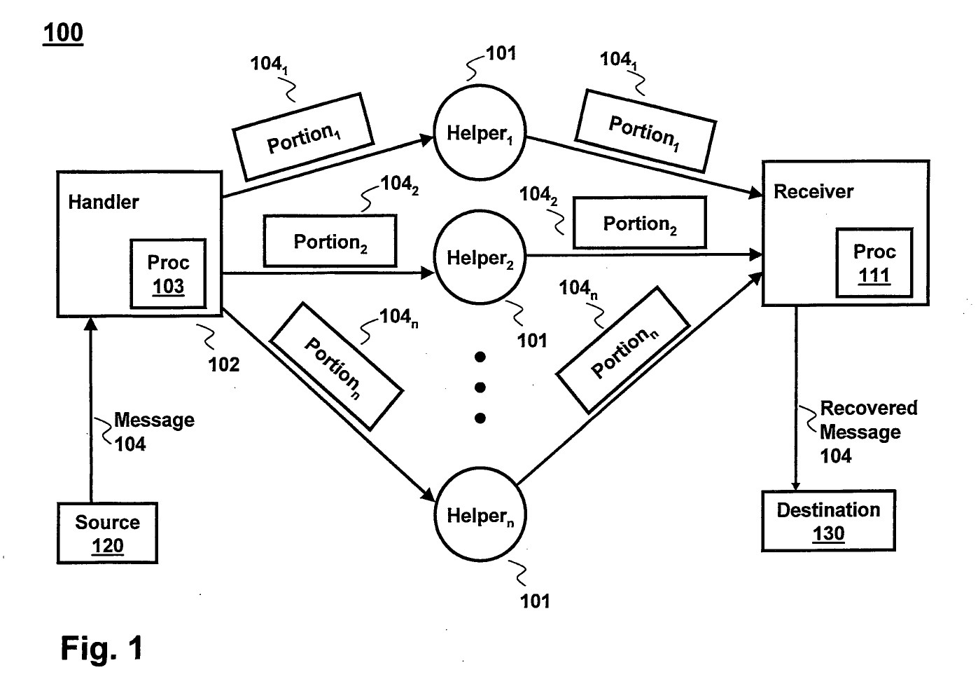

FIG. 1 illustrates an exemplary system 100 for communicating a message according the present disclosure. System 100 includes plural helper nodes 101, and an information transmitter 102 (referenced herein as a handler) that includes a processor 103. A receiver 110 is also depicted for receiving a message sent by the handler 102.

The processor 103 can detect a number of the nodes 101 within communication range of the information transmitter 102, or handler, as helper nodes. The processor 103 can process a message 104 into a number of portions 104₁-104ₙ as a function of the number of helper nodes 101 detected. The processor 103 can transmit at least one of the portions 104₁-104ₙ of the message 104 to at least one of the helper nodes 101 for wireless communication of the at least one portion by the at least one of the helper nodes 101. The helper nodes 101 can communicate the at least one portion to the receiver 110, for example via radio. In an exemplary embodiment, the helper nodes 101 all transmit at a given radio frequency within the same limited bandwidth, interfering with one another on purpose. Such an “interfere on purpose” scheme is termed interference multiple access (IMA).

The receiver 110 can be configured in known fashion to detect interfering signals (e.g. to detect messages from multiple transmitters transmitting at the same frequency within a common limited bandwidth). Such a receiver capability can be exploited in the exemplary embodiment of FIG. 1 by having multiple helper nodes 101 which transmit on the same radio frequency within the same bandwidth, and at the same time to transmit the different portions 104₁-104ₙ of the same message 104. That is, processor 103 transmits a different one of the portions 104₁-104ₙ to each of the helper nodes 101. However, as will be described, any or all of the portions of the message 104 can be transmitted to any or all of the helper nodes 101, provided the message has been appropriately apportioned in the manner as described herein.

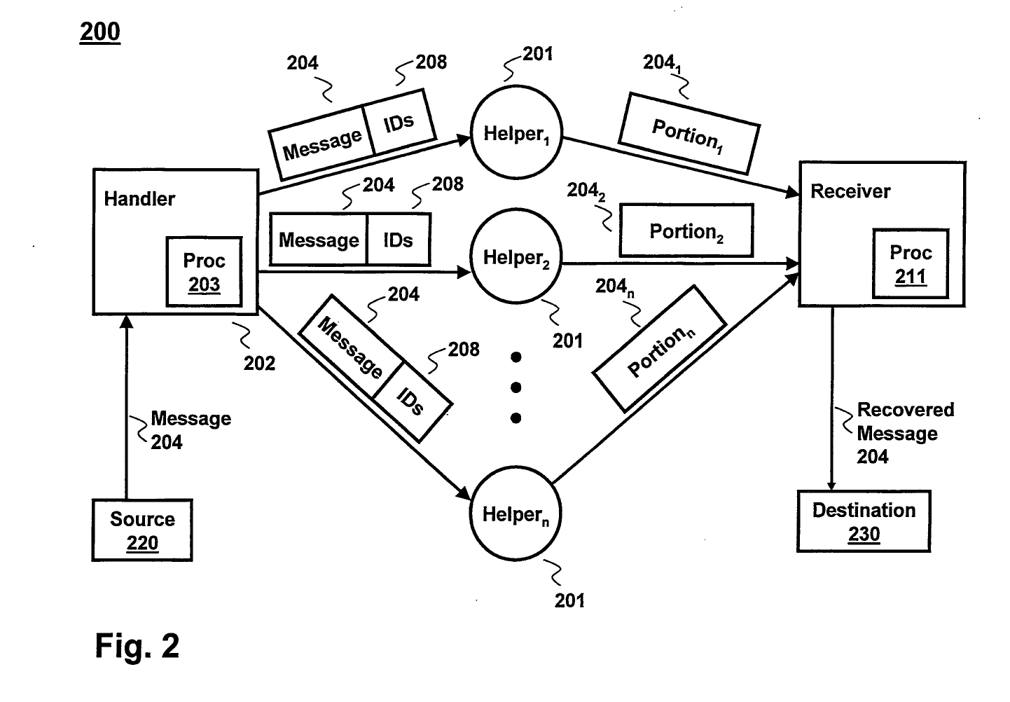

In an exemplary embodiment, regardless of the portion or portions 104₁-104ₙ of the message 104 received, each of helper nodes 101 is configured to transmit the respective portion 104₁-104ₙ of the message 104. While only three nodes and three corresponding portions are illustrated in FIGS. 1 and 2, any number of nodes can be used in exemplary embodiments. In addition, the handler 102 can also function as one or more of the helper nodes 101 and transmit in cooperation with one or more of the helper nodes 101.

In exemplary embodiments, the helper nodes 101 can optionally send one or more types of notifications (e.g. acknowledgements). For example, a helper node 101 can send an acknowledgement to the handler 102 upon reception and/or transmission of at least one of portions 104₁-104ₙ. A helper node 101 can also forward to the handler 102 an acknowledgement and/or a request for retransmission from the receiver 110. The helper node 101 can also acknowledge a request for retransmission and retransmit at least part of the portions 104₁-104ₙ as may be requested (e.g. by the receiver 110 and/or a destination 130 of the message). In embodiments where a source 120 that provides the message is in communication with the handler 102, the handler 102 can collect plural acknowledgements from one or more helper nodes 101 from receiver 110. By collecting the plural acknowledgements, the handler 102 can then send an acknowledgement representing plural acknowledgements to the source 120.

The respective portions 104₁-104ₙ can be transmitted by the nodes 101 via radio. As already mentioned, signals containing respective portions 104₁-104ₙ of the message 104 can be transmitted as co-channel interfering signals. As used herein, co-channel interfering signals are signals which interfere as a result of being transmitted on the same frequency, or within a limited bandwidth at the same time.

In an exemplary embodiment, the helper nodes 101 can communicate with receiver 110 according to a communication protocol and/or medium access controller (MAC) employed by the receiver 110. The helper nodes 101 can act as independent nodes where transmitted packets are addressed to a destination 130 of the message 104 and/or to receiver 110. The destination 130 and/or receiver 110 can be part of a network (e.g. a TCP/IP network like the Internet or a mobile network) for communication to devices on the network external to the system. In an exemplary embodiment, a “send at will” protocol can be implemented such that one or more helper nodes 101 send a message once they have one to send (e.g. upon receipt). In an exemplary embodiment with an IMA scheme implemented at the MAC of receiver 110, a frame-based request-to-send/clear-to-send protocol can be employed where helper nodes 101 individually, without coordinating with each other, follow the IMA protocol and engage in a communication process with the destination 130 and/or receiver 110 where the nodes 101 are assigned a time slot to send packets. If the receiver 110 is part of an IMA system, then multiple nodes can receive a clear-to-send notification in a particular data transmission time slot. The clear-to-send notification can be sent by the receiver 110.

When using the send-at-will protocol the helper nodes 101 can act as a bent pipe. Use of a bent pipe can improve transmission speed. For example, the helper nodes 101 can be configured to not decode or error correct a received portion 104₁-104ₙ but instead retransmit the portion 104₁-104ₙ in an expedited manner (e.g. as soon as possible). In an exemplary system using at least one helper node 101 as a bent pipe, the handler 102 can structure packets in exactly the same way as required by the communication protocol and MAC employed by the receiver 110. If the MAC employs a protocol that requires rough timing synchronization or prior assignments of which nodes are allowed to transmit and when, the helper nodes 101 can still be employed as a bent pipe, in which case, the handler 102 can orchestrate adherence of the bent pipe signals to the receiver 110 protocol expectations (e.g. rough timing, grouping, header content, etc).

Exemplary embodiments of the helper nodes 101 can perform demodulation and remodulation to recover the bits of a portion and possibly repackage and/or break up the portions even more before transmitting the respective portion. If desired, the helper nodes 101 can change the protocol of received information so as to be compatible with the MAC of the receiver 110, since the helper nodes 101 can act as individual processors with the ability process (e.g. parse and/or code and/or frame) information to be transmitted.

In exemplary embodiments, the receiver 110 is a known multi-user detection (MUD) receiver, which can be used to jointly demodulate co-channel interfering digital signals. MUD can detect signals and recover data in non-orthogonal multiple access schemes or overload spread spectrum schemes. Optimal MUD based on the maximum likelihood principle can operate by comparing the received signal with a set of possibilities that may have occurred at the transmitters of the co-channel interfering digital signals, such that a received waveform can be determined. While a non-optimal MUD can be employed, the same underlying principle can govern data recovery success, namely that interfering signals are not simply treated as additional noise, but rather as extractable signals of interest. A description of MUD receivers can be found, for example, in U.S. Pat. No. 7,092,452 B2 and U.S. Pat. No. 7,058,422 B2, the disclosures of which are hereby incorporated herein by reference in their entireties.

In exemplary embodiments, the receiver 110 can be configured to receive and demodulate the portions 104₁-104ₙ of the message 104, such as those sent via helper nodes 101. The message 104 can be recovered in receiver processor 111 by combining the received portions 104₁-104ₙ of the message 104. The recovered message 104 can then remain at the receiver 110 or be forwarded to a destination 130 via any known means, either directly or indirectly.

When the receiver 110 is configured with MUD, the nodes 101 can transmit co-channel interfering signals containing the portions 104₁-104ₙ of the message 104 for receipt at receiver 110. Receiver processor 111 can then recover the entire message 104 by demodulating the co-channel interfering digital signals by MUD to recover the portions 104₁-104ₙ. Thus, the helper nodes 101 do not need to coordinate with each other or share information. The helper nodes 101 can act as independent users in the system using the MUD. The receiver 110 can then combine the portions of the message. The resultant data of the combination can include part or all of the message or data stream.

The respective portions 104₁-104ₙ can be transmitted by helper nodes 101 via radio or using any other communications scheme. For example, a fractionated downlink approach can be used, for example, with adaptive modulation and coding to maximize system capacity and/or throughput. Many multiple access schemes can be used to cooperatively transmit information from nodes 101 to receiver 110. In one example, a fractionated downlink can be implemented using OFDMA (orthogonal frequency division multiple access) and one or more different subcarriers can be used with each helper node 101 that needs to transmit a respective portion 104₁-104ₙ. For example, if there are two nodes 101 using OFDMA for transmitting a respective portion 104₁, 104₂, each node 101 can transmit using a different half of the available subcarriers. Helper nodes 101 can be assigned a different fraction of the number of subcarriers if desired. In another example, a fractionated downlink can be implemented using CDMA (code division multiple access) to share available bandwidth, for example in an adaptive approach. For example, if helper nodes 101 are using CDMA for transmitting a respective portion 104₁, 104₂, each helper node 101 can transmit using a different bandwidth length signature sequence and/or modulation scheme (e.g. BPSK or QPSK). Helper nodes 101 can be assigned a different rate of the bandwidth if desired. Here, the spreading can be adapted based on the number of nodes 101 that need to transmit a respective portion 104₁-104ₙ. For example, as more nodes 101 are used, the length of the spreading codes can be increased, in addition to adaptive modulation and channel coding.

Receiver processor 111 can use any known method to combine the received portions of the message 104. In exemplary embodiments, helper nodes 101 can transmit signals that contain portions 104₁-104ₙ which at least partially overlap or employ a scheme for any means of coding across portions 104₁-104ₙ. For example, the receiver 110 can receive multiple copies of the same portion or packet (e.g. a repetition code). An appropriate scheme can be implemented at the receiver processor 111 to decode and error correct to recover the message 104 based on the multiple copies. Alternatively, the portions 104₁-104ₙ can be non-overlapping so that bandwidth is not wasted by transmitting redundant data. Receiver processor 111 can send acknowledgment and/or requests for retransmission as appropriate to any of the helper nodes 101 or the handler 102.

FIG. 2 illustrates another exemplary system for communicating a message 204. In the exemplary embodiment, processor 203 can assign identifiers 208 for the portions 204₁-204ₙ of the message 204. The identifiers 208 can be included with the portions of the message 204 (e.g. in at least one header with the portions), to indicate the helper node 201 that is assigned to transmit the respective portions 204₁-204ₙ and to identify where the portions fits within the entire message. The handler 102 can then broadcast the message 204 to the helper nodes 201 with the identifiers 208. The identifiers 208 assign each of the portions of the message to a respective one of the helper nodes 201. Based on the information contained in the identifier, each helper node 101 can determine which portion is to be transmitted (e.g. for reception at receiver 210).

In exemplary embodiments, aspects of the embodiments of FIG. 1 and FIG. 2 can be combined and are not necessarily mutually exclusive. For example, some helper nodes 101 can receive portions via a broadcast and others can receive individual overlapping or non-overlapping portions.

In exemplary embodiments, any or all of the helper nodes 101 and the handler can be satellites of a body (e.g. Earth) and the receiver 110 can be situated on or flying over the body.

Any or all of processor 103, processors included in the helper nodes 101, and receiver processor 111 can include, for example, at least one of a general purpose processor, specialized purpose processor, FPGA, DSP, desktop computer, laptop computer, server, handheld computer, embedded computing system and/or workstation. The processors can include respective computer-readable recording media, each medium having a program recorded thereon which causes a processor to execute steps of the current disclosure. An exemplary program of the present disclosure may be an application program that is operable with an OS (operating system) of any or all of the processors. A computer-readable recording medium may be, for example, a memory which is removable or non-removable.

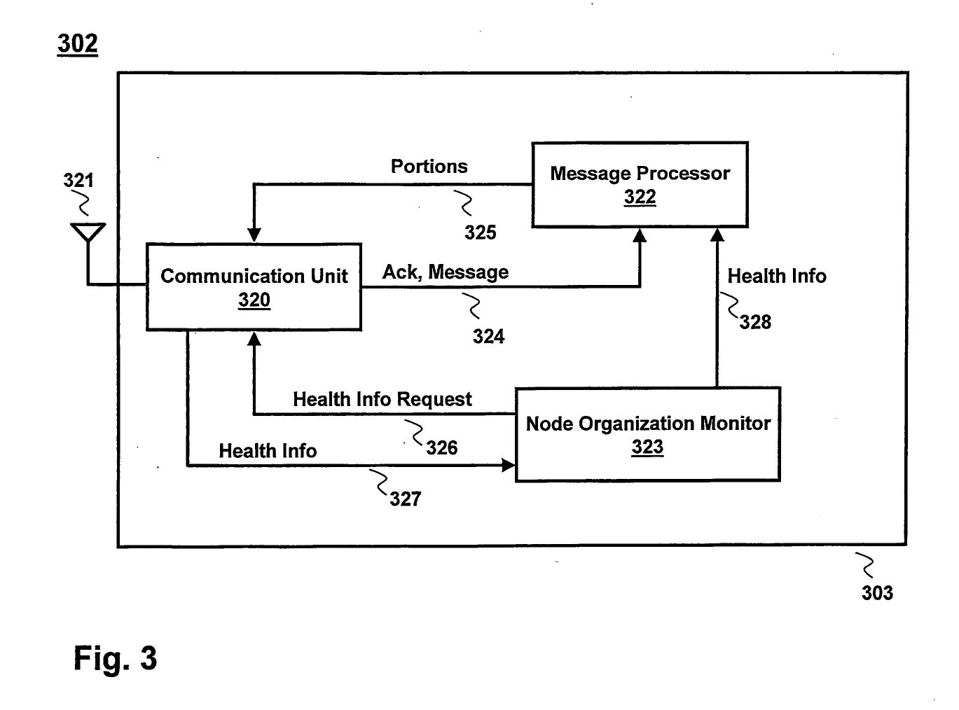

FIG. 3 illustrates an exemplary information transmitter, or handler 302, which can be used as the handler 102 and handler 202 in FIGS. 1 and 2, respectively. The handler 302 includes a processor 303 and an interface 321 (e.g. an antenna system). The processor 303 includes a communication unit 320 for communication through the interface 321, a message processor 322, and a node organization monitor 323. The communication unit 320 and the interface 321 can be used to transmit and receive signals. For example, the communication unit 320 and the interface 321 can comprise a radio that is capable of communicating with at least one of a message source 120, helper nodes 101, receiver 110, and destination 130.

The processor 303 can generate the message 104 or the interface 321 can directly or indirectly receive the message 104 from a source 120. The message 104 can be received via the communication unit 320 and the interface 321. Handler 302 can communicate with one or more sources 120 and with helper nodes 101 using any known method (e.g. wired or wireless) which can be the same or different for each respective link. In embodiments where a radio is used for communication with one or more sources and for communication with helper nodes 101, communication can occur using different or the same radio frequency, power, and/or speed.

In an exemplary embodiment, a message 104 intended to be transmitted to the receiver 110 can be passed to the message processor 320 via link 324. Health information 326, or additional data, can be passed to the communication unit 320 for transmission to an appropriate device via an appropriate at least one of communication message format, communication protocol, modulation, and frequency to allow for a link to be established. The link can communicate, for example, with a message source 120, helper 101, receiver 110, or destination 130). The communication unit 320 can optionally perform at least demodulation, decoding, and routing of the message 104 for processing and transmission, or can receive health information messages or acknowledgements or other messages from helpers 101. The communication unit can optionally receive and demodulate signals from receiver 110 or from an alternative computer that can control the handler 102.

The node organization monitor 323 can request the health information (e.g. about the helper nodes) via link 326 and receive health information via link 327. The node organization monitor 323 can also store received health information for use in the message processor 322. Health information can include, for example, at least one of link quality of the respective node, link latency of the respective node, and link speed of the respective node. The link 326 and link 327 connect for sending and receiving, respectively, to communication unit 320 and interface 321. Requests for updates to the node information can be periodic or in response to an event, for example receipt of instructions or an advisory that the network has changed configurations. The node organization monitor 323 can detect a number of the helper nodes 101 within communication range of the handler 102. The detection of the number of helper nodes 101 can occur as part of a request and response with respect to helper node health information.

The message processor 322 can use the health information from node organization monitor 323, sent via link 328, to process the message 104 into the number of portions 104₁-104ₙ. For example, the message 104 can be processed into the number of portions 104₁-104ₙ as a function of at least one of the number of helper nodes detected, at least part of available predetermined health information, size of the message 104, and available storage space (e.g. buffer size or remaining space in a buffer) of the helper nodes 101. In the processing of the message 104, the message processor 322 can identify which detected helper nodes 101 are to be designated to transmit a respective one of the portions 104₁-104ₙ. The message 104 can be processed into the number of portions 104₁-104ₙ in order to optimize for a given metric (e.g. latency, individual power per node, total power per node, throughput, range, etc).

It will be appreciated that not all of the detected nodes 101 may be designated to transmit a respective one of the portions 104₁-104ₙ. Also, the nodes 101 may have different health information. For example, when the health information of a given node 101 is lower than others or there are not enough portions of the message to spread throughout the helper nodes 101, taking into account, for example, required overhead taken by each helper node 101, the message processor 322 can designate less than all of the detected nodes 101 as helper nodes 101 for transmitting 104₁-104ₙ of the message 104.

The message processor 322 can forward the portions 104₁-104ₙ of the message 104 to the communication unit 320 via link 325. The communication unit 320 can then transmit at least one of the portions 104₁-104ₙ of the message 104 to at least one of the helper nodes 101. The communication unit 320 can send acknowledgements and/or requests for retransmission to the message processor 322 via link 324 for action by the message processor 322. For example, the communication unit 320 can pass along or initiate acknowledgements and/or requests for retransmission to/from at least one of the helper nodes 101, a source node 120, or receiver 110, or a destination 130.

In exemplary embodiments where the helper nodes 101 are satellites, the message processor 322 can take into account the position of the satellites and/or which area of the body being orbited is being faced. Thus, satellites with the best “view” of the receiver 110 can be prioritized by the message processor 322.

The health information can include, for example, health information related to at least one of the helper nodes 101 and data links through the helper nodes 101. The health information can include at least one of link quality of the respective node, link latency of the respective node, and link speed of the respective node. More specifically, the health information can include at least one of transmit power, processing power, throughput, goodput, SNR (signal to noise ratio), bandwidth, and latency of at least one of any of the links between the handler 102 and the helper nodes 101 or between the helper nodes 101 and receiver 110. The health information can be detected in known fashion using techniques for evaluating the quality and/or capacity of the various links (e.g. RF channels) of the system.

In an embodiment with a radio broadcast, as illustrated in FIG. 2, or a multicast, the message processor 322 can assign identifiers 208 to the portions 204₁-204ₙ so as to designate a helper node 201 that is to transmit each determined portion. The identifiers 208 can be sent to the communication unit 320 via link 325 and transmitted with the message 204 for reception at helper nodes 201. The identifiers 208 can be an explicit indication of which helper node 201 is to transmit which portion 204₁-204ₙ or any information which can allow the helper nodes 201 to determine a respective portion to be transmitted. This information can include, for example, the health information so that the helper nodes 201 can determine their respective portions using the same methods of message processor 322 of the handler 302. For example, the helper nodes 201 can implement the same partitioning algorithm and have the same rules as to the order of the assignments of portions 204₁-204ₙ. Then, each helper node 201 can run the optimal partitioning algorithm after receiving the message 204 and reading the identifier with the health information of other helpers. The helper nodes 201 then can determine their respective portions to be transmitted and transmit the respective portion, ignoring the portions that are not to be transmitted.

In an exemplary embodiment with three helper nodes 101₁, 101₂, 101₃ detected by handler 302, the handler 302 can determine that message communication should be optimized for low latency. In this example, the communication unit 320 receives health information related to latency via link 327 and forwards the health information to node organization monitor 323. By way of example, the health information indicates that helper node 101₁ has a latency of 3 minutes while helper nodes 101₂ and 101₃ have latencies of 20 milliseconds and 40 milliseconds, respectively. This latency information can be the latency of links between respective helper nodes and the receiver 110, for example. In this case, the message processor 322 receives the health information 328 and determines that a message 104 should be divided into two portions 104₁ and 104₂. Because helper node 101₁ has a latency significantly larger than the other two, the message processor 322 can determine that only helper nodes 101₂ and 101₃ are needed for transmission in this example. Each helper node 101 can receive a portion with a size at least approximately proportional to the latency, which is the metric for optimizization in this example. Since the latency of helper node 101₂ and 101₃ is half as much as the latency of helper node 101₃, message processor 322 designates helper node 101₂ to send a portion 104₁ twice as large as the portion 104₂ for the helper node 101₃. Thus, in the given example, the message processor 322 can determine that helper node 101₁ is to receive no data for retransmission while helper nodes 101₂ and 101₃ receive determined portions containing ⅔ and ⅓ of the message 104, respectfully. When this example is applied to the FIG. 2 embodiment, the handler 202 would broadcast the message 204 for receipt at the helper nodes 201₁, 201₂, 201₃. Identifiers 208 would also be broadcast. Based on the identifiers 208, helper node 201₁ determines that it is to transmit no data while helper nodes 201₂ and 201₃ determine that they are to send a determined ⅔ and ⅓ of the message 204, respectfully.

In exemplary embodiments, any of the links between the handler 102 and the helper nodes 101 or between the helper nodes 101 and receiver 110 can include other processors (e.g. routers or retransmitters) for the purpose of relaying data. Information can then be transmitted to more distant helper nodes that cannot be directly reached from the handler node 102.

The helper nodes 101 can be positioned relatively close to the handler 102, to improve the system performance by increasing the received signal strength. The handler 102 can transmit to helpers 101 at a high rate sufficient to transmit at least one of the portions 104₁-104ₙ of the message 104 to at least one of the helper nodes 101 in a short duration of time. The helper nodes 101, any or all of which may be very distant from receiver 110 can then transmit (e.g. simultaneously) at a relatively low rate to the helper nodes 101, as compared to the transmission rate of the handler 102.

The handler 102 can transmit via any known method to communicate all or part of a message 104 to the helper nodes 101. In one example, the handler 102 can unicast a payload to each helper node 101. Various embodiments can use a broadcast and/or multicast method to communicate the message 104 in parallel with the identifiers 208. A plurality of helper nodes 201 can receive the messages 204 and the identifier 208 by listening (e.g. at the same time) to the transmission from handler 202.

Use of different helper nodes can make it more difficult for geo-location of a source 120 of a message (e.g. by an adversary). By using low-powered nodes, geo-location of individual nodes can also be made more difficult. Use of different low power helper nodes 101 can significantly increase the total system throughput from the source 120 to a destination 130 because the capacity (throughput per unit time) of each link is additive for each low SNR links that is simultaneously interfering. Data can be distributed from the handler node 102 to the helper nodes 101 very quickly, allowing a longer cycle time to follow in which each helper node 101 simultaneously transmits a respective portion of the message 104. For example, for the case of N identical SNR links between N helper nodes 101, respectively, and a receiver 110, each helper node 101 can transmit 1/Nth of the data to the receiver 110 during the same time interval T. If the source 120 with the same SNR link to the destination 130 were to transmit the entire message itself, it would take a time interval of duration T*N. Embodiments with two helper nodes 101 can thus transmit at twice the rate of a conventional transmitter using the entire channel all the time. If helper nodes 101 employ TDMA to communicate with the receiver 110 instead of using a MUD scheme, for example, the total throughput can revert back to the throughput of a single transmitter that sends the entire message by itself. Another asynchronous choice of multiple access scheme which allows for the total throughput to be higher, and which does not require a MUD in the receiver 110, is OFDMA. If chip-level synchronization were possible among the helper nodes 101, then another high throughput choice for simultaneous transmission without using a MUD in receiver 110 would be synchronous CDMA. However, if chip synchronization were possible, an overpacking set of CDMA signals might be designed according to the emerging methods known in the art of information theory that would work in conjunction with a MUD receiver to further increase the total throughput of the handler/helper link.

The message 104 can include an electronic message and/or a file. In another example, the message 104 can include at least one of video, images, voice, text, and binary data. The portions 104₁-104ₙ need not be contiguous, in addition to overlapping or not overlapping. In transmitting the message 104 and the portions 104₁-104ₙ, the transmissions can be packetized and/or otherwise processed for reliable and/or encrypted transmission and reception. An exemplary system can act as at least part of a proxy between the source 120 and the destination 130. The source 120 and destination 130 need not have knowledge of the inner workings, or even of the existence, of the system. An exemplary system can act as a link between a single source 120 and a single destination 130, and can be optimized accordingly. The source 120 can then be “fooled” into thinking it is communicating directly with the destination 130, and that the link quality was greatly improved, allowing the communication rate to be increased when communicating through a handler 102 and plural helper nodes 101.

At least one of the transmissions including the portions 104₁-104ₙ can include a designation (e.g. an address) of at least one destination of the portions 104₁-104ₙ. For example, a designation of the receiver 110 and/or a designation of the final destination for the message 104 can be included when transmitting from the handler 102 and/or the helper nodes 101 for receipt of the designation by the receiver 110. The receiver 110 can then transmit the recovered message 104 to the destination based on the designation.

Exemplary embodiments can exclude additional features, for example to lower cost and/or increase efficiency. For example, the helper nodes 101 can be configured to receive only one of the portions 104₁-104ₙ. In another example, the helper nodes 101 can be not configured to request the entire message 104. The helper nodes 101 can be configured such that they do not communicate any of the portions 104₁-104ₙ between them. The helper nodes 101 can be configured such that they do not communicate between each other knowledge of which portions 104₁-104ₙ are contained in which helper nodes.

Various elements of exemplary embodiments of the system can provide functions other than those that may be implied by their names. For example, a handler 102 may act as at least one of a source 120, a helper node 101, or a receiver 110.

The above description is presented to enable a person skilled in the art to make and use the systems and methods described herein, and is provided in the context of a particular application and its requirements. Various modifications to the embodiments will be readily apparent to those skilled in the art, and the generic principles defined herein may be applied to other embodiments and applications without departing from the spirit and scope of the claims. Thus, there is no intention to be limited to the embodiments shown, but rather to be accorded the widest scope consistent with the principles and features disclosed herein.

What is claimed is:

1. A system for communicating a message, comprising:
plural nodes; and
an information transmitter that includes a processor configured to:
detect a number of the nodes within communication range of the information transmitter as helper nodes;
process a message into a number of portions as a function of the number of helper nodes detected; and
transmit at least one of the portions of the message to at least one of the helper nodes for wireless communication of the at least one portion by the at least one helper node.

2. A system of claim 1, wherein the processor is configured to:
assign identifiers for the portions of the message; and
broadcast the message to the helper nodes with the identifiers, wherein the identifiers assign each of the portions of the message to a respective one of the helper nodes.

3. A system of claim 1, wherein the processor of the information transmitter is configured to process the message into the number of portions as a function of predetermined health information of at least one of the nodes.

4. The system of claim 1, wherein the helper nodes are each configured to transmit a respective portion of the message via radio such that radio signals containing the respective portions are co-channel interfering signals.

5. The system of claim 4, comprising a receiver configured to:
receive the co-channel interfering signals respectively containing the portions of the message; and
recover the message by demodulating the co-channel interfering digital signals in a MUD receiver to recover the portions and combining the portions of the message.

6. The system of claim 1, wherein the processor of the information transmitter is configured to act as one of the nodes and transmit a respective portion of the message.

7. The system of claim 1, comprising a receiver configured to receive the portions of the message and recover the message by combining the portions of the message.

8. The system of claim 7, wherein:
the information transmitter is configured to receive from a source the message and a designation of a destination,
the information transmitter is configured to transmit the designation for receipt by the receiver, and
the receiver is configured to transmit the recovered message to the destination based on the designation.

9. The system of claim 1, wherein the health information comprises at least one of link quality of the respective node, link latency of the respective node, and link speed of the respective node.

10. The system of claim 1, wherein the respective portions of the message do not overlap.

11. The system of claim 1, wherein the processor is configured to transmit the portions of the message to the nodes by individually transmitting the respective portion to each node.

12. An information transmitter, comprising:
a processor configured to:
detect a number of nodes within communication range of the information transmitter as helper nodes;
process a message into a number of portions as a function of the number of helper nodes detected; and
transmit at least one of the portions of the message to at least one of the helper nodes for wireless communication of the at least one portion by the at least one helper node.

13. The information transmitter of claim 12, wherein the processor is configured to:
assign identifiers for the portions of the message; and
broadcast the message to the helper nodes with the identifiers, wherein the identifiers assign each of the portions of the message to a respective one of the helper nodes.

14. The information transmitter of claim 12, wherein the processor is configured to transmit the portions of the message to the nodes by individually transmitting the respective portion to each node.

15. A method for wireless transmission, comprising
detecting a number of the nodes within communication range of the information transmitter as helper nodes;
processing a message into a number of portions as a function of the number of nodes detected; and
transmitting at least one of the portions of the message to at least one of the helper nodes for wireless communication of at least one portion by the at least one helper node.
